(19) United States
(12) Patent Application Publication
(10) Pub. No.: US 2025/0217870 A1
(43) Pub. Date: Jul. 3, 2025

(54) NON-TRANSITORY STORAGE MEDIUM STORING PROGRAM, MANAGEMENT SYSTEM, MANAGEMENT DEVICE AND METHOD OF MANAGING SHIPMENT

(71) Applicant: BROTHER KOGYO KABUSHIKI KAISHA, Nagoya (JP)

(72) Inventor: Shuhei KATO, Nagoya (JP)

(21) Appl. No.: 18/931,269

(22) Filed: Oct. 30, 2024

(30) Foreign Application Priority Data
Dec. 27, 2023 (JP) 2023-220409

(51) Int. Cl. G06Q 30/0601; B41J 2/175; B41J 29/00; G06F 3/12; G06K 15/00; G06Q 10/0834

(52) U.S. Cl. CPC G06Q 30/0635; B41J 2/17566; B41J 29/00; G06F 3/1293; G06K 15/4065; G06Q 10/08345

(57) ABSTRACT

A non-transitory storage medium stores a program executable by a computer of a management device configured to manage shipment of first consumables consumed in a printer under a contract with the user. When executed by the computer, the program is configured to execute, in a case where the terms of the contract includes a first terms, setting a first amount of shipment to a unit-shipment-amount indicating an amount of the first consumables shipped at a time to the user, and, in a case where the terms of the contract includes a second term indicating an amount of the first consumables consumed in the printer in a corresponding-period is larger than that of the first term, setting a second amount of shipment to the unit-shipment-amount. The amount of the first consumables indicated by the second amount of shipment is larger than that indicated by the first amount of shipment.

### REFERENCE TO RELATED APPLICATIONS

This application claims priority from Japanese Patent Application No. 2023-220409 filed on Dec. 27, 2023. The entire content of the priority application is incorporated herein by reference.

### BACKGROUND ART

The present disclosure relates to a non-transitory storage medium storing a management program, a management system, a management device and a management method.

There has been known a device configured to manage shipment of consumables consumed in a printer to a user. For example, the printer consumes toner of CMYK toner cartridges as the consumables and transmits the remaining amount of the toner of each of the CYMK cartridges to a server. The server determines whether the toner of any one of the CMYK toner cartridges is to be shipped based on the transmitted remaining amount of the toner of each of the CYMK toner cartridges. In a case where one of the CYMK cartridges is to be shipped, the server estimates the time of shipment of the other three CYMK cartridges other than the one toner cartridge to be shipped. In a case where the estimated shipment time of any of the three toner cartridges is near to the shipment time of the one toner cartridge to be shipped, the server ships the toner cartridge to be shipped and the toner cartridge having the shipment time near to the toner cartridge to be shipped together with each other, that is, the toner cartridges are shipped by the combined shipping.

### SUMMARY

In the above described shipping system, there is no detailed explanation in which how the server ships the consumables under the contract with the user.

The present disclosure provides a management program, a management system, a management device and a management method capable of shipping the consumables under the contract with the user.

In one aspect of the disclosure, a non-transitory storage medium stores a program executable by a computer of a management device configured to manage shipment, to a user, of first consumables consumed in a printer under a contract with the user. When executed by the computer, the program is configured to execute, in a case where the terms of the contract includes a first terms, setting a first amount of shipment to a unit-shipment-amount indicating an amount of the first consumables shipped at a time to the user, and, in a case where the terms of the contract includes a second term indicating an amount of the first consumables consumed in the printer in a corresponding-period is larger than that of the first term, setting a second amount of shipment to the unit-shipment-amount. The amount of the first consumables indicated by the second amount of shipment being larger than that indicated by the first amount of shipment. The corresponding-period is a period corresponding to a corresponding one term of each of the first term and the second term of the contract.

In another aspect of the disclosure, a management system includes a printer configured to consume first consumables, and a management device communicatable with the printer, a terminal of the user, or the printer and the terminal of the user. The management device is configured to manage shipment of the first consumables to the user under a contract with the user. The printer, the terminal of the user, or the printer and the terminal of the user includes a first controller. The first controller is configured to execute transmitting the terms of the contract to the management device. The management device includes a second controller. The second controller is configured to execute receiving the transmitted terms of the contract, in a case where the terms of the contract includes a first term, setting a first amount of shipment to a unit-shipment-amount indicating an amount of the first consumables shipped to at a time to the user, and, in a case where the terms of the contract includes a second term indicating an amount of the first consumables consumed in the printer in a corresponding-period, which is a period corresponding to the second term of the contract, is larger than that of the first term, setting a second amount of shipment to the unit-shipment-amount. The amount of the first consumables indicated by the second amount of shipment is larger than that indicated by the first amount of shipment.

In another aspect of the disclosure, a management device configured to manage shipment, to a user, of first consumables consumed in a printer under a contract with the user includes a controller. The controller is configured to execute, in a case where the terms of the contract includes a first term, setting a first amount of shipment to a unit-shipment-amount indicating an amount of the first consumables shipped at a time to the user, and, in a case where the terms of the contract includes a second term indicating an amount of the first consumables consumed in the printer in a corresponding-period, which is a period corresponding to the second term of the contract, is larger than that of the first term, setting a second amount of shipment to the unit-shipment-amount. The amount of the first consumables indicated by the second amount of shipment is larger than that indicated by the first amount of shipment.

In another aspect of the disclosure, a method of managing shipment, to a user, of first consumables consumed in a printer under a contract with the user includes, in a case where the terms of the contract includes a first term, setting a first amount of shipment to a unit-shipment-amount indicating an amount of the first consumables shipped at a time to the user, and, in a case where the terms of the contract includes a second term indicating an amount of the first consumables consumed in the printer in a corresponding-period, which is a period corresponding to the second term of the contract, is larger than that of the first term, setting a second amount of shipment to the unit-shipment-amount. The amount of the first consumables indicated by the second amount of shipment is larger than that indicated by the first amount of shipment.

### BRIEF DESCRIPTION OF DRAWINGS

The objects, features, advantages, and technical and industrial significance of the present disclosure will be better understood by reading the following detailed description of the embodiments, when considered in connection with the accompanying drawings, in which:

FIG. 1 is a block diagram illustrating an electrical structure of a management system;

FIG. 2 is a view for explaining types of a contract;

FIG. 3 is a view illustrating for explaining a management information storage area;

FIG. 4 is a view for explaining history information;

FIG. 5 is a view for explaining receiving and transmitting data between each of a printer and a terminal, and a management device; and

FIG. 6 is a flowchart for a management process.

### DESCRIPTION

There will be described a management system 1 as an embodiment of the present disclosure with reference to the drawings. The referenced drawings are used for explaining the technical features which can be adopted in the present disclosure. Accordingly, the structures and the controls of the devices described in the present disclosure are just examples for explanation thereof, and the technical features of the present disclosure are not limited to the described structures and the controls of the devices.

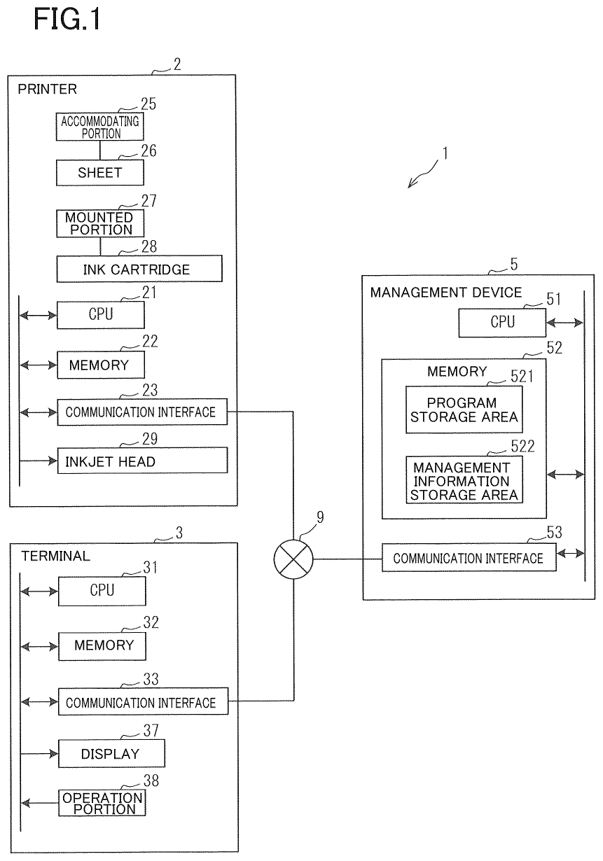

There will be described an outline and an electrical structure of a management system 1 with reference to FIG. 1. The management system 1 is a system for providing the user with a service by the supplier, which will be described below, related to a printer 2. When the contract regarding the service has been concluded between the supplier and the user, the supplier provides the user with the service under a type of the contract by the management system 1. In the present embodiment, “the contract has been concluded” indicates a case where the user newly concludes the contract with the supplier and a case where the user renews the contract with the supplier. Renewing the contract includes a case where the type of the current contract is the same as the type of the previous contract and a case where the type of the current contract is not the same as the type of the previous contract.

The management system 1 includes the printer 2, a terminal 3 and a management device 5. The printer 2 and the terminal 3 are used by the user. The management device 5 functions as a server and is managed by the supplier of the service. The printer 2, the terminal 3 and the management device 5 are connected to the Internet 9 so as to communicate with each other via the Internet 9. It is noted that the management system 1 may include another printer (which is not illustrated) in addition to the printer 2, and may include another terminal (which is not illustrated) in addition to the terminal 3.

The printer 2 has a printing function, and includes a CPU 21, a memory 22, a communication interface 23, an accommodating portion 25, a mounted portion 27 and an ink-jet head 29. The CPU 21 controls the printer 2. The memory 22 includes a transitory memory and a non-transitory memory, and the memory 22 stores various kinds of information. For example, the memory 22 stores a printer ID and remaining-amount information of the printer 2. The printer ID is an identifier for identifying each of the plurality of printers. The remaining-amount information indicates a remaining-amount of ink in an ink cartridge 28. The remaining-amount information is detected by a remaining-amount sensor (which is not illustrated) disposed in the accommodating portion 25, and the remaining-amount information is calculated by the CPU 21 at each printing.

The communication interface 23 is a driver device for connecting to the Internet 9. Sheets 26 are accommodated in the accommodating portion 25. The sheet 26 is an example of consumables consumed in the printer 2. Specifically, the sheet 26 is an example of printing medium. The ink cartridge 28 is mounted on the mounted portion 27. The ink cartridge 28 accommodates ink, and supplies the ink to the ink-jet head 29. The ink cartridge 28 is an example of consumables consumed in the printer 2.

The ink-jet head 29 ejects ink supplied from the ink cartridge 28 on the sheet 26 supplied from the accommodating portion 25 by the control of the CPU 21. As a result of this, printing by the ink-jet head 29 on the sheet 26 is performed. Accordingly, in the printer 2, the sheet 26 and the ink in the ink cartridge 28 are consumed at each printing. That is, when one sheet of the sheet 26 is consumed in the printing, an amount, corresponding to the printing of the one sheet, of the ink in the ink cartridge 28 is consumed. In other words, the sheet 26 is consumed each time when the ink in the ink cartridge 28 is consumed.

The terminal 3 is a device such as a smart phone or a personal computer, owned by the user. The terminal 3 includes a CPU 31, a memory 32, a communication interface 33, a display 37 and an operation portion 38. The CPU 31 controls the terminal 3. The memory 32 includes a transitory memory and a non-transitory memory, and stores various kinds of information. For example, the memory 32 stores programs executed by the CPU 31. The communication interface 33 is a driver device for connecting to the Internet 9. The display 37 displays various kinds of screens by the control of the CPU 31. The operation portion 38 includes buttons or a touch panel and so on, and outputs, to the CPU 31, signals in accordance with operations by the user.

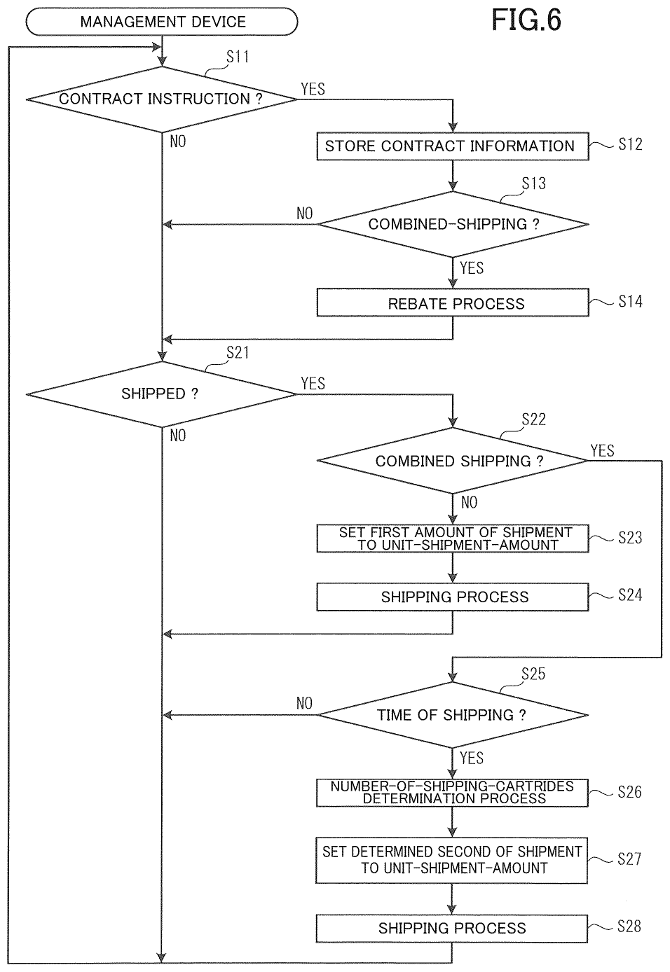

The management device 5 manages shipment of the ink cartridge 28 to the user based on the terms of the contract, that is, the content of the contract, with the user, which will be described below. The management device 5 includes a CPU 51, a memory 52 and a communication interface 53. The CPU 51 controls the management device 5. The memory 52 includes a transitory memory and a non-transitory memory, and stores various kinds of information. The memory 52 includes a program storage area 521 and a management information storage area 522. The program storage area 521 stores programs executed by the CPU 51. The programs include a management program for controlling a management process (see FIG. 6), which will be described below. The management information storage area 522 will be described below. The communication interface 53 is a drive device for connecting to the Internet 9.

There will be described the number of printed sheets and an amount of consumed ink. In the present embodiment, the number of printed sheets is the number of sheets of the sheets 26 consumed in printing in the printer 2. The amount of consumed ink is a consumed-volume (mL) of the ink cartridge 28 consumed in printing of the printer 2. In the present embodiment, “the number” is a concept including “the number of pieces”, “the number of sheets”, “the volume”, and the like. An example of the case where the numbers of pieces are different from each other is a case where the number of the ink-cartridges (the number is “one”) is different from the number of the same type ink-cartridges (the number is “two”). An example of the case where the numbers of sheets are different from each other is a case where the number of the sheets (the number is “1000”) is different from the number of the sheets (the number is “2000”). An example of the case where the volumes are different from each other is a case where the volume of one ink cartridge (100 mL) is different from the volume of another ink cartridge (200 mL) while the numbers of the ink cartridge are the same as each other (the numbers are “one”).

There will be described the service. In the present embodiment, the service includes “a flat rate service”, “an each-time-shipping service” and “a combined-shipping service”. The flat rate service is a charging service having a flat rate system regarding the printer 2. The flat rate service is a service in which a rate to be paid from the user to the supplier is a flat contracted rate (for example, 8000 YEN) in a case where the user prints the sheets in a renewal term (for example, one month) up to a contracted number of sheets (for example, 1000 sheets). The flat rate service is a service in which the rate to be paid from the user to the supplier becomes a rate in which an additional charge (for example, 10 YEN/sheet) based on the number of printed sheets over the contracted number of sheets is added to the flat contracted rate in a case where the number of printed sheets used in the renewal term exceeds the contracted number of sheets. In this manner, in the flat rate service, a rate system to the sheets 26 in a case where the number of printed sheets does not exceed the contracted number of sheets is different from a rate system in a case where the number of printed sheets exceeds the contracted number of sheets. That is, the contracted number of sheets is a threshold of the rate system to the sheet 26 in the number of printed sheets. The number of printed sheets is accumulated during the renewal term, and when the renewal term expires, the accumulated number of printed sheets is reset to zero. That is, the renewal term is a term in which the number of printed sheets is accumulated, and corresponds to the terms of the contract (the content of the contract).

Each of the each-time-shipping service and the combined-shipping service is a service in which in a case where the remaining amount of the ink in the ink cartridge 28 becomes equal to or smaller than a predetermined remaining amount in the renewal term, a new ink cartridge 28 is automatically ordered and shipped to the user. In the following description, the number of the ink cartridges 28 shipped at a time to the user is defined as “a unit-shipment-amount”. The unit-shipment-amount in the each-time-shipping service is a first amount of shipment. The first amount of shipment is not limited to a specified amount, however, the first amount of shipment is one in the present embodiment. The unit-shipment-amount in the combined-shipping service is a second amount of shipment, and the second amount of shipment is plural in the present embodiment. That is, the second amount of shipment is greater than the first amount of shipment. In the following description, the shipping manner in the each-time-shipping service, that is, the shipping manner in which the unit-shipment-amount is the first amount of shipment is referred to as “an each-time shipping”, and the shipping manner in the combined-shipping service, that is, the shipping manner in which the unit-shipment-amount is the second amount of shipment is referred to as “a combined-shipping”.

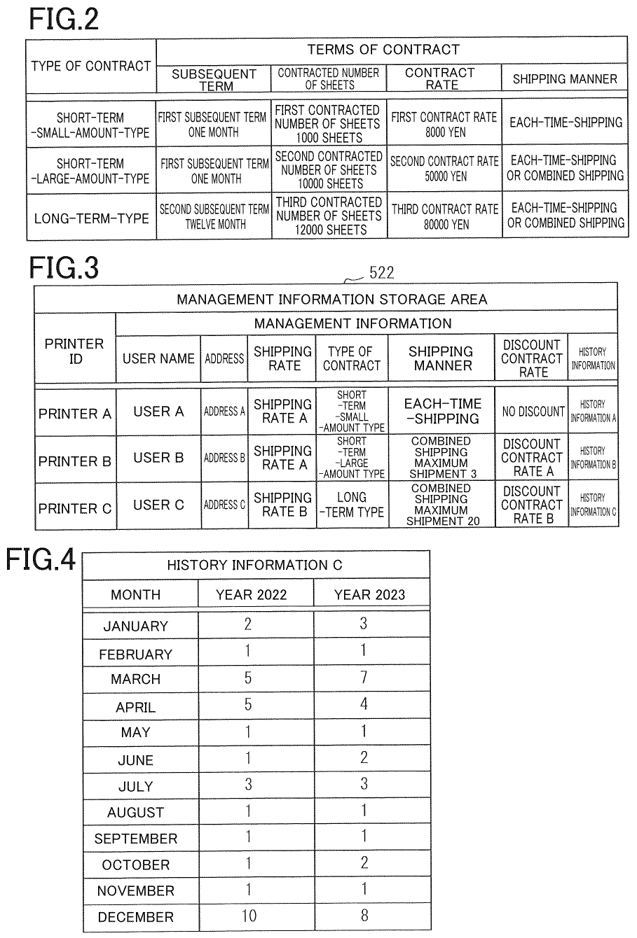

There will be described the type of the contract with reference to FIG. 2. In the present embodiment, the type of contract includes three types of the contract, such as a short-term-small-amount type, a short-term-large-amount type and a long-term-type. The short-term-small-amount type, the short-term-large-amount type and the long-term-type are different from each other in the terms of the contract (the content of the contract). The terms of the contract includes the renewal term, the contracted number of sheets, the contract rate and the shipping manner.

In the short-term-small-amount type, the renewal term is a first renewal term (one month in FIG. 2), the contracted number of sheets is a first contracted number of sheets (1000 sheets in FIG. 2), the contract rate is a first contract rate (8000 YEN in FIG. 2), and the shipping manner is the each-time shipping.

In the short-term-large-amount type, the renewal term is the first renewal term (one month in FIG. 2), the contracted number of sheets is a second contracted number of sheets (10000 sheets in FIG. 2), the contract rate is a second contract rate (50000 YEN in FIG. 2), and the shipping manner is the each-time shipping or the combined-shipping. In the short-term-large-amount type, the user can select one of the each-time shipping and the combined-shipping as the shipping manner.

In the long-term-type, the renewal term is a second renewal term (twelve months in FIG. 2), the contracted number of sheets is a third contracted number of sheets (12000 sheets in FIG. 2), the contract rate is a third contract rate (80000 in FIG. 2), and the shipping manner is the each-time shipping or the combined-shipping. In the long-term-type, the user can select one of the each-time shipping or the combined-shipping as the shipping manner.

In the present embodiment, the second renewal term is longer than the first renewal term. The second contracted number of sheets is larger than the first contracted number of sheets. The third contracted number of sheets is larger than the first contracted number of sheets. The third contracted number of sheets/the second renewal term, that is, the quotient of the third contracted number of sheets divided by the second renewal term is equal to the first contracted number of sheets/the first renewal term, that is, the quotient of the first contracted number of sheets divided by the first renewal term. The second contract rate is higher than the first contract rate. The third contract rate is higher than the first contract rate.

According to the above described terms of the contract, in the respective types of the contract, the amounts of consumed ink in the respective renewal terms are different from each other. The larger the number of printed sheets in the renewal term becomes, the larger the amount of consumed ink in the renewal term becomes. The longer the renewal term becomes, the larger the number of printed sheets in the renewal term becomes. The larger the contracted number of sheets becomes, the larger the number of printed sheets in the renewal term becomes. As a result of this, the longer the renewal term becomes, the larger the amount of consumed ink in the renewal term becomes. The larger the contracted number of sheets becomes, the larger the amount of consumed ink in the renewal term becomes.

While the renewal term in the short-term-small-amount type is the first renewal term (one month), which is the same as the renewal term in the short-term-large-amount type, the second contracted number of sheets (10000 sheets) is larger than the first contracted number of sheets (1000 sheets). As a result, the number of printed sheets in the renewal term in the short-term-large-amount type becomes larger than that in the short-term-small-amount type. Accordingly, the amount of consumed ink in the renewal term in the short-term-large-amount type becomes larger than that in the short-term-small-amount type.

While the quotient of the contracted number of sheets/the renewal term in the short-term-small-amount type (1000 sheets per one month) is the same as the quotient of the contracted number of sheets/the renewal term in the long-term-type (1000 sheets per one month), the second renewal term (twelve months) is longer than the first renewal term (one month). As a result, the number of printed sheets in the renewal term in the long-term-type is larger than that in the short-term-small-amount type. Accordingly, the amount of consumed ink in the renewal term in the long-term-type becomes larger than that in the short-term-small-amount type.

There will be described the management information storage area 522 with reference to FIG. 3. Management information is stored in the management information storage area 522 in a state in which the management information is associated with the printer ID. In FIG. 3, the management information is associated with each of the printers A, B and C. The management information is used for managing the service. The management information includes information related to the contract, and, in the present embodiment, the management information includes the user name, the user address, the shipping rate, the contract type, the shipping manner, a discount contract rate and history information.

The user address indicates an address of the user as a destination of the shipment of the ink cartridge 28. In FIG. 3, the addresses of the user A, B and C are respectively associated with the printers A, B and C. The shipping rate indicates a shipping rate from a shipper of the shipment of the ink cartridge 28 to the destination of the shipment of the ink cartridge 28. The shipper of the shipment is, for example, a warehouse in which the ink cartridges 28 are stored, and the warehouse exists at each service location. The shipping rate is, for example, a rate determined by the carrier of the shipment based on a distance from the warehouse of the shipper of the shipment to the destination of the shipment. In FIG. 3, the shipping rates A, A and B are associated with the printers A, B and C. The shipping rate B is set to be lower than the shipping rate A. In this case, the distance from the shipper of the shipment to the destination of the shipment of the printer C is shorter than that of each of the printers A and B.

The user name indicates the name of the user of the printer 2 identified by the printer ID, that is, the user name indicates the name of the user who has concluded the contract with the supplier. In FIG. 3, the users A, B and C are respectively associated with the printers A, B and C. The contract type indicates the type of the contract between the user and the supplier. The user concludes the contract with the supplier for each printer ID. In FIG. 3, the short-term-small-amount type, the short-term-large-amount type and the long-term-type are respectively associated with the printers A, B and C, as the contract type.

The each-time shipping or the combined-shipping is set to the shipping manner. In FIG. 3, the each-time shipping, the combined-shipping and the combined-shipping are respectively associated with the printers A, B and C, as the shipping manner. Moreover, in a case where the shipping manner is the combined-shipping, a maximum limit of the shipment is also set. The maximum limit of the shipment is a maximum limit of the second amount of shipment, that is, a maximum number of the ink cartridges 28 shipped to the user by the combined-shipping. The maximum limit of the shipment is designated by the user. In FIG. 3, three cartridges and twenty cartridges are respectively associated with the printers B and C, as the maximum limit of the shipment.

The discount contract rate indicates the discounted contract rate. In FIG. 3, no discount, the discount contract rates A and B are respectively associated with the printers A, B and C, as the discount contract rate. In a case where the shipping manner is the combined-shipping, the contract rate is discounted. “No discount” indicates that the contract rate is not discounted. In a case where the contracts are the same contract type as each other, the lower the shipping rate becomes, the higher the discount amount and the discount ratio become.

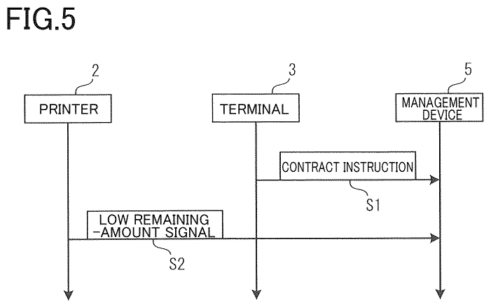

The history information indicates past shipment history of the ink cartridge 28 based on the past shipping date and the past number of shipped cartridges of the ink cartridge 28. In the present embodiment, the history information indicates the number of shipped cartridges of the ink cartridge 28 of each month in every year (see FIG. 4). In FIG. 3, the history information A, B and C are respectively associated with the printers A, B and C.

There will be described the history information C as an example of the history information with reference to FIG. 4. The history information C indicates the number of shipped cartridges of the ink cartridge 28 of each month in year 2022 and year 2023, as of Dec. 31, 2023. For example, the history information C indicates that a total of ten ink cartridges 28 are shipped in December 2022.

There will be described data receiving and transmitting among each of the printer 2 and the terminal 3 and the management device 5 with reference to FIG. 5. When the user concludes the contract with the supplier, the user operates the terminal 3 with the operation portion 38 to conclude the contract with the supplier. For example, the user selects the contract type from among the short-term-small-amount type, the short-term-large-amount type and the long-term-type, and inputs the selected contract type into the terminal 3. In a case where the user selects the short-term-large-amount type or the long-term-type as the contract type, the user selects the each-time shipping or the combined-shipping as the shipping manner, and the user inputs the selected shipping manner into the terminal 3. That is, the user inputs a response, into the terminal 3, indicating which of the first amount of shipment (the each-time shipping) and the second amount of shipment (the combined-shipping) is to be set to the unit-shipment-amount. In a case where the user selects the combined-shipping as the shipping manner, the user inputs the maximum limit of the shipment into the terminal 3.

The user inputs the user name, the user address, the printer ID and other information into the terminal 3. The user performs transmitting operation of an instruction for the contract to the management device 5 via the operation portion 38. The instruction for the contract indicates the input user name, the input user address, the input printer ID, the input contract type, the input shipping manner, the input maximum limit of the shipment and so on. In the following description, the information indicated by the instruction for the contract is referred to as “contract information”. When the transmitting operation of the instruction for the contract to the management device is received in the terminal 3, the CPU 31 transmits the instruction for the contract to the management device 5 (S1). In this case, in the management device 5, the CPU 51 receives the instruction for the contract (S1). As a result of this, the contract between the user and the supplier is concluded, and the user can receive the service.

In the printer 2, when the remaining amount of ink stored in the memory 22 reaches the predetermined remaining amount, the CPU 21 transmits a low remaining-amount signal to the management device 5 (S2). The low remaining-amount signal indicates that the remaining amount of ink has reached the predetermined remaining amount, and indicates the printer ID. In this case, in the management device 5, the CPU 51 receives the low remaining-amount signal (S2). As a result of this, the ink cartridge 28 is automatically shipped to the user.

There will be described the management process with reference to FIG. 6. When the power of the management device 5 is turned on, the CPU 51 reads a management program from the program storage area 521 and executes the management process.

When the management process starts, the CPU 51 determines whether the CPU 51 receives or not the instruction for the contract transmitted from the terminal 3 by the process at S1 illustrated in FIG. 5 (S11). In a case where the CPU 51 does not receive the instruction for the contract (S11: NO), the CPU 51 moves the process to the determination at S21.

When receiving the instruction for the contract (S11: YES), the CPU 51 stores, in the management information storage area 522 illustrated in FIG. 3, the pieces of information included in the contract information in a state in which the pieces of information are associated with each other (S12). As illustrated in FIG. 3, for example, in a case where the user A concludes the contract with the supplier for the printer A, the CPU 51 stores “the printer A” into the printer ID field, and stores “the user A”, “the user address A”, “the short-term-small-amount type” and “the each-time shipping” into the user name filed, the user address field, the contract type, and the shipping manner filed each corresponding to “the printer A”. It is noted that the CPU 51 identifies the shipper of the shipment based on the stored user address. The CPU 51 determines the shipping rate based on the user address and the identified shipper of the shipment. The CPU 51 stores the determined shipping rate into the shipping rate field in the management information storage area 522.

As illustrated in FIG. 6, the CPU 51 determines whether the shipping manner stored in the process at S12 is the combined-shipping or not (S13). For example, in a case of the printer A, the shipping manner is set to the each-time shipping. In a case where the shipping manner is set to the each-time shipping (S13: NO), the CPU 51 moves the process to the determination at S21. For example, in a case of each the printer B or the printer C, the shipping manner is set to the combined-shipping. In a case where the shipping manner is set to the combined-shipping (S13: YES), the CPU 51 executes a rebate process (S14).

In the rebate process (S14), the CPU 51 changes the contract rate to the discount contract rate based on the contract type and the shipping rate. In the present embodiment, in the case where the contract type is the same type, the CPU 51 sets a first discount contract rate to the discount contract rate when the shipping rate is a first shipping rate, and sets a second discount contract rate, which is lower than the first discount contract rate, to the discount contract rate when the shipping rate is a second shipping rate that is lower than the first shipping rate. For example, in the case of the printer B, the CPU 51 stores the discount contract rate A into the discount contract rate filed corresponding to the printer B in the management information storage area 522. For example, in the case of the printer C, the CPU 51 stores the discount contract rate B into the discount contract rate field corresponding to the printer C in the management information storage area 522. The CPU 51 executes a process in which the CPU 51 charges the user for the discount contract rate in lieu of the second contract rate or the third contract rate at the expiration of the renewal term.

After the rebate process (S14), the CPU 51 moves the process to the determination at S21. The CPU 51 determines whether it is necessary to ship the ink cartridge 28 to the user or not (S21). For example, in a case where the first shipment of the ink cartridge 28 has been performed after the contract information is stored in the process at S12 and the CPU 51 does not receive the low remaining-amount signal transmitted from the printer 2 at S2 illustrated in FIG. 5, the CPU 51 determines that it is not necessary to ship the ink cartridge 28 to the user (S21: NO). In this case, the CPU 51 returns the process to S11.

For example, in the case where the first shipment of the ink cartridge 28 has not been performed after the contract information is stored in the process at S12 or in a case where the CPU 51 receives the low remaining-amount signal transmitted from the printer at S2 illustrated in 2 FIG. 5, the CPU 51 determines that it is necessary to ship the ink cartridge 28 to the user (S21: YES). In this case, the CPU 51 determines the shipping manner, corresponding to the printer ID of the instruction for the contract or the printer ID indicated by the low remaining-amount signal, is the combined-shipping or not with reference to the management information storage area 522 illustrated in FIG. 3 (S22).

For example, in a case where the printer ID is the printer A, the shipping manner is the each-time shipping (See FIG. 3). In a case where the shipping manner is the each-time shipping (S22: NO), the CPU 51 sets the first amount of shipment to the unit-shipment-amount (one cartridge in the present embodiment) in the memory 52 (S23). The CPU 51 executes a shipping process (S24). In the shipping process, the CPU 51 transmits, to the server of the carrier (which is not illustrated) via the Internet 9, an instruction for shipping in which the first amount of shipment of the ink cartridge 28 set at the process at S23 is to be shipped to the user corresponding to the printer ID indicated by the low remaining-amount signal. The CPU 51 returns the process to the determination at S11.

For example, in a case where the printer ID is the printer B or the printer C, the shipping manner is the combined-shipping (See FIG. 3). In a case where the shipping manner is the combined-shipping (S22: YES), the CPU 51 determines whether the time of shipping has come or not (S25). In the process at S25, for example, for the printer ID indicated by the low remaining-amount signal, the CPU 51 determines whether the number of the receipt of the low remaining-amount signals becomes equal to the number of the ink cartridges 28 which has already been shipped or not. That is, the CPU 51 determines whether the user has the stock of the ink cartridge 28 or not.

For example, in a case where the number of the receipt of the low remaining-amount signals is smaller than the number of the ink cartridges 28 which had been already shipped to the user, the user has the stock of the ink cartridge 28. In this case, the CPU 51 determines that the time of shipping does not come (S25: NO), and the CPU 51 returns the process to the determination at S11. For example, in a case where the first shipment of the ink cartridge 28 has not been performed after the contract information is stored in the process at S12, or in a case where the number of the receipt of the low remaining-amount signals is equal to the number of the ink cartridges 28 which has been already shipped to the user, the user does not have the stock of the ink cartridge 28. In this case, the CPU 51 determines that the time of shipping has come (S25: YES), the CPU 51 executes a number-of-shipping-cartridges determination process (S26).

In the number-of-shipping-cartridges determination process, the CPU 51 determines the second amount of shipment. In the present embodiment, the CPU 51 determines an estimated-number-of-consumed-cartridges. The estimated-number-of-consumed-cartridges is the number of the ink cartridges 28 estimated to be consumed in the printer 2 by the user in the renewal term. Information for determining the estimated-number-of-consumed-cartridges has already been stored in the memory 52. The information for determining the estimated-number-of-consumed-cartridges is, for example, the average number of the cartridges 28 of all uses consumed in the printer 2 in the renewal term of each the contract type. The information for determining the estimated-number-of-consumed-cartridges is, for example, the average number of the ink cartridges 28 of a certain user consumed in the printer 2 in the renewal term of each the contract type. The CPU 51 determines the estimated-number-of-consumed-cartridges based on the information for determining the estimated-number-of-consumed-cartridges.

Here, there will be defined a specified period and a set period. The specified period is a specified period, for example, from December to January in a year. The set period is a period equal to the renewal term, or shorter than the renewal term, for example, a period starting from the time of the current shipment of the ink cartridge 28 to the time of the next shipment of the ink cartridge 28. A future specified period is included in the set period, the CPU 51 determines a specified-number-of-consumed-cartridges by referring the history information corresponding to the printer ID indicated by the low remaining-amount signal stored in the management information storage area 522. In the present embodiment, the future specified period is the specified period which comes next, relative to the present time. The specified-number-of-consumed-cartridges is the number of the ink cartridges 28 which has been consumed in the printer 2 by the user in a past specified period. The past specified period may be all the past specified periods relative to the present time, or be the past (last) specified period, for example, the past specified period included in the past one year.

The CPU 51 determines the number-of-cartridges-can-be-consumed by considering an expiration date of the ink cartridge 28 and by referring the history information corresponding to the printer ID indicated by the low remaining-amount signal stored in the management information storage area 522. The number-of-cartridges-can-be-consumed is the number of the ink cartridges 28 estimated to be consumed in the printer 2 until the expiration date of the ink cartridge 28 comes.

The CPU 51 determines a provisional-number-of-shipped-cartridges based on the determined estimated-number-of-consumed-cartridges, the determined specified-number-of-consumed-cartridges and the determined number-of-cartridges-can-be-consumed. The provisional-number-of-shipped-cartridges may be the average number of the estimated-number-of-consumed-cartridges, the specified-number-of-consumed-cartridges and the number-of-cartridges-can-be-consumed, or may be the median number of the estimated-number-of-consumed-cartridges, the specified-number-of-consumed-cartridges and the number-of-cartridges-can-be-consumed. Moreover, the provisional-number-of-shipped-cartridges may be the largest number of the estimated-number-of-consumed-cartridges, the specified-number-of-consumed-cartridges and the number-of-cartridges-can-be-consumed, or the smallest number of the estimated-number-of-consumed-cartridges, the specified-number-of-consumed-cartridges and the number-of-cartridges-can-be-consumed. The provisional-number-of-shipped-cartridges may be determined by assigning weight to the estimated-number-of-consumed-cartridges, the specified-number-of-consumed-cartridges and the number-of-cartridges-can-be-consumed. The CPU 51 determines the second amount of shipment by choosing smaller one from the determined provisional-number-of-shipped-cartridges and the maximum limit of the shipment. That is, the second amount of shipment is equal to or smaller than the maximum limit of the shipment.

For example, in the printer B, in a case where the number of five is determined as the provisional-number-of-shipped-cartridges based on the estimated-number-of-consumed-cartridges, the specified-number-of-consumed-cartridges and the number-of-cartridges-can-be-consumed, the second amount of shipment becomes three because the maximum limit of the shipment of the printer B is three. For example, in the printer C, in a case where the number of nine is determined as the provisional-number-of-shipped-cartridges based on the estimated-number-of-consumed-cartridges, the specified-number-of-consumed-cartridges and the number-of-cartridges-can-be-consumed, the second amount of shipment becomes nine because the maximum limit of the shipment of the printer C is twenty.

The CPU 51 sets the second amount of shipment determined by the number-of-shipping-cartridges determination process (S26) to the unit-shipment-amount in the memory 52 (S27). The CPU 51 executes the shipping process (S28). In the shipping process, the CPU 51 transmits, to the server of the shipper (which is not illustrated) via the Internet 9, the instruction for shipping by which the second amount of shipment of the ink cartridge 28 set by the process at S27 is shipped to the user corresponding to the printer ID indicated by the low remaining-amount signal. The CPU 51 returns the process to the determination at S11.

There will be described main effects achieved by the management system 1 in the present embodiment. Other effects other than the effects, which are described below, are also achieved by the management system 1. Effects similar to the effects of the management system 1 are also achieved by the management device 5, the management program or the method executed by the management process.

The CPU 51 sets the first amount of shipment to the unit-shipment-amount in the short-term-small-amount type (S23), and sets the second amount of shipment to the unit-shipment-amount in each of the short-term-large-amount type and the long-term-type (S27). As a result of this, the management system 1 can ship the ink cartridge 28 based on the terms of the contract (the content of the contract) with the user. Since the second amount of shipment is larger than the first amount of shipment, it is possible to prevent the management system 1 from shipping the excessive number of the ink cartridges 28 to the user in the short-term-small-amount type. Moreover, it is possible to reduce the shipping cost of the supplier in each of the short-term-large-amount type and the long-term-type.

The renewal term in the short-term-small-amount type is the first renewal term, and the renewal term in the long-term-type is the second renewal term. Since the second renewal term is longer than the first renewal term, the amount of consumed ink in the renewal term in the long-term-type becomes larger than that in the short-term-small-amount type. The CPU 51 sets the first amount of shipment to the unit-shipment-amount in the short-term-small-amount type (S23), and sets the second amount of shipment to the unit-shipment-amount in the long-term-type (S27). Since the second amount of shipment is larger than the first amount of shipment, it is possible to prevent the management system 1 from shipping the excessive number of the ink cartridges 28 to the user in the short-term-small-amount type. Moreover, it is possible to reduce the shipping cost of the supplier in the long-term-type.

Since the sheet 26 is consumed while the ink in the ink cartridge 28 is consumed, the larger the number of the contracted number of sheets becomes, the larger the amount of consumed ink becomes in the renewal term. The contracted number of sheets in the short-term-small-amount type is the first contracted number of sheets, and the contracted number of sheets in the short-term-large-amount type is the second contracted number of sheets. Since the second contracted number of sheets is larger than the first contracted number of sheets, the amount of ink consumed in the renewal term in the short-term-large-amount type becomes larger than that in the short-term-small-amount type. The CPU 51 sets the first amount of shipment to the unit-shipment-amount in the short-term-small-amount type (S23), and sets the second amount of shipment to the unit-shipment-amount in the short-term-large-amount type (S27). Since the second amount of shipment is larger than the first amount of shipment, it is possible to prevent the management system 1 from shipping the excessive number of the ink cartridges 28 to the user in the terms of the contract of the short-term-small-amount type. Moreover, it is possible to reduce the shipping cost of the supplier in the short-term-large-amount type.

In a case where the response included in the contract information indicates that the first amount of shipment is to be set to the unit-shipment-amount (S22: NO), the CPU 51 sets the first amount of shipment to the unit-shipment-amount (S23). In a case where the response included in the contract information indicates that the second amount of shipment is to be set to the unit-shipment-amount (S22: YES), the CPU 51 sets the second amount of shipment to the unit-shipment-amount (S27). According to this, for example, the user can select one of the first amount of shipment and the second amount of shipment and set it to the unit-shipment-amount, based on whether the user permits having the stock of the cartridge or not. That is, the user can choose one of the each-time shipping and the combined-shipping based on whether the user permits having the stock of the cartridge or not. Accordingly, the management system 1 enables the user to adjust the number of stocks of the ink cartridges 28 kept by the user in each of the short-term-large-amount type and the long-term-type.

In a case where the response included in the contract information indicates that the second amount of shipment is to be set to the unit-shipment-amount (S13: YES), the CPU 51 changes the second contract rate to the discount contract rate (S14). In a case where the second amount of shipment is set to the unit-shipment-amount, the shipping cost is reduced comparing to a case where the first amount of shipment is set to the unit-shipment-amount. In the case where the shipping cost is reduced in the terms of the contract in each of the short-term-large-amount type and the long-term-type, the management system 1 can return, to the user, the rebate corresponding to the reduction of the shipping cost by changing the second contract rate to the discount contract rate.

In a case where the shipping rate of the ink cartridge 28 is the first shipping rate, the CPU 51 changes the second contract rate to the first discount contract rate. In a case where the shipping rate of the ink cartridge 28 is the second shipping rate, the CPU 51 changes the second contract rate to the second discount contract rate (S14). According to this, the management system 1 can return, to the user, the rebate in accordance with the shipping rate in each of the short-term-large-amount type and the long-term-type. Since the second shipping rate is lower than the first shipping rate, and the second discount contract rate is lower than the first discount contract rate, the lower the shipping rate becomes, the larger the amount of the rebate retuned from the management system 1 to the user becomes.

The CPU 51 sets the second amount of shipment based on the estimated-number-of-consumed-cartridges to the unit-shipment-amount (S26, S27). According to this, the management system 1 can prevent the occurrence of the shortage or the surplus of the unit-shipment-amount in each of the short-term-large-amount type and the long-term-type.

In a case where the future specified period is included in the set period, the CPU 51 sets the second amount of shipment based on the specified-number-of-consumed-cartridges to the unit-shipment-amount (S26, S27). According to this, the management system 1 can prevent the occurrence of the shortage or the surplus of the unit-shipment-amount in each of the short-term-large-amount type and the long-term-type.

The CPU 51 sets the second amount of shipment equal to or smaller than the maximum limit of the shipment to the unit-shipment-amount (S26, S27). According to this, the management system 1 enables the user to adjust the number of stocks of the ink cartridges 28 kept by the user in each of the short-term-large-amount type and the long-term-type.

The CPU 51 sets the second amount of shipment based on the expiration date of the ink cartridge 28 to the unit-shipment-amount (S26, S27). According to this, the management system 1 can prevent the possibility of the situation in which the user cannot consume all the ink cartridges 28 of the unit-shipment-amount by the time of the expiration date of the ink cartridge 28 in each of the short-term-large-amount type and the long-term-type.

It is noted that the ink cartridges 28 in the present embodiment correspond to “first consumables” in the present disclosure. The terms of the contract of the short-term-small-amount type corresponds to “a first term of the contract” in the present disclosure. The terms of the contract of each of the short-term-large-amount type and the long-term-type corresponds to “a second term of the contract” in the present disclosure. The process at each of S12, S23 and S27 corresponds to “a setting process” in the present disclosure. The sheets 26 correspond to “second consumables” in the present disclosure. The process of obtaining the contract information in the process at S1 (S11: YES) corresponds to each of “a first obtaining process” and “a second obtaining process” in the present disclosure. The process at S14 corresponds to a changing process in the present disclosure. The process at S26 corresponds to each of “a first specifying process” and “a second specifying process” in the present disclosure.

The present disclosure may be changed from the above described embodiment. For example, the CPU 51 may grant a privilege to the user instead of or in addition to changing the second contract rate to the discount contract rate. For example, the privilege is rewarding points which can be used for paying the contract rate. The privilege is not limited to the points, and may be coupons and so on. In this case, the management system 1 can return, to the user, the rebate corresponding to the reduction of the shipping rate in each of the short-term-large-amount type and the long-term-type by granting the privilege to the user when the shipping cost is reduced.

Moreover, in a case where the shipping rate for shipping the second amount of shipment of the ink cartridges 28 to the user is the first shipping rate, the CPU 51 grants a first privilege to the user, and in a case where the shipping rate is the second shipping rate lower than the first shipping rate, the CPU 51 may grant the user a second privilege higher than the first privilege for the user. In this case, the management system 1 can return, to the user, the rebate in accordance with the shipping rate in each of the short-term-large-amount type and the long-term-type.

The management device 5 may manage shipment of the sheet 26 to the user or manage shipment of other consumables to the user instead of or in addition to the shipment of the ink cartridge 28. The printer 2 may not be in the inkjet type printing. The contract type is not limited to the type in the above described embodiment. For example, one of the short-term-large-amount type and the long-term-type may be dispensed with, and the contract type may include 4 or more contract types. The management device 5 may be constituted of a plurality of servers. In this case, the management process may be executed by distributed processing by the plurality of servers. The management device 5 may be general purpose PCs or smartphones and so on.

In the above described embodiment, the number of the ink cartridges 28 shipped at a time to the user in the each-time shipping is different from that in the combined-shipping. On the other hand, the number of the ink cartridges 28 shipped at a time to the user in the each-time shipping may be the same as that in the combined-shipping. In this case, the amount of the ink in the ink cartridges 28 shipped in the combined-shipping may be larger than the amount of the ink in the ink cartridges 28 shipped in the each-time shipping.

In the above described embodiment, when the renewal term has passed, the user is charged the contract rate. On the other hand, the management system 1 may be configured such that the user can receive the service when the contract rate is paid by the user. In the above described embodiment, the discount amount of the contract rate or the rate (ratio) of the discount may be the same as each other regardless of the shipping rate, and the contract rate may not be discounted.

In the above described embodiment, the CPU 51 determines the provisional-number-of-shipped-cartridges based on the estimated-number-of-consumed-cartridges, the specified-number-of-consumed-cartridges and the number-of-cartridges-can-be-consumed, and chooses smaller one of the provisional-number-of-shipped-cartridges and the maximum limit of the shipment and sets the chosen one to set to the second amount of shipment. On the other hand, the CPU 51 may determine the provisional-number-of-shipped-cartridges based on one or two of the estimated-number-of-consumed-cartridges, the specified-number-of-consumed-cartridges and the number-of-cartridges-can-be-consumed. The CPU 51 may set the maximum limit of the shipment to the second amount of shipment without considering the estimated-number-of-consumed-cartridges, the specified-number-of-consumed-cartridges and the number-of-cartridges-can-be-consumed. The CPU 51 may determine the second amount of shipment based on the estimated-number-of-consumed-cartridges, the specified-number-of-consumed-cartridges and the number-of-cartridges-can-be-consumed without considering the maximum limit of the shipment.

The order of the processes is not limited to the order of the processes described in the above described embodiment. For example, the processes at S23, S26 and S27 for setting the unit-shipment-amount may be performed at the timing of the process at S12. In the above described embodiment, the determination of whether the ink cartridge 28 is to be shipped or not is performed in accordance with the determination of whether there is the low remaining-amount signal or not in the process at S21. On the other hand, the determination of whether the ink cartridge 28 is to be shipped or not may be performed in accordance with the determination of whether a predetermined period has passed or not. That is, the shipping process may be executed in every predetermined period. Every predetermined period may include, for example, every renewal term, a predetermined date in every month, and so on.

In the above described embodiment, the management system 1 may dispense with the terminal 3. In this case, the user may perform operations for concluding the contract with the supplier via an operation portion (which is not illustrated) of the printer 2. When the CPU 21 detects the operations for concluding the contract with the supplier, the CPU 21 may transmit an instruction for the contract to the management device 5. In this case, the management device 5 may receive the instruction for the contract from the printer 2.

Micro Computer, ASIC (Application Specific Integrated Circuits), FPGA (Field Programmable Gate Array) and so on may be used as processors instead of the CPUs 21, 31 and 51. The management process may be executed by distributed processing by a plurality of processors. A non-transitory storage medium such as the memory 52 may be a storage medium capable of storing information regardless of a period for which the information has been stored or held. The non-transitory storage medium may not include a transitory storage medium (for example, transmission signals). The program may be, for example, downloaded from the server connected to the network (which is not illustrated), that is, transmitted as transmission signals, and may be stored in the memory 52. In this case, the program may be stored in the non-transitory storage medium such as HDD provided in the server.

What is claimed is:

1. A non-transitory storage medium storing a program executable by a computer of a management device configured to manage shipment, to a user, of first consumables consumed in a printer under a contract with the user,
wherein, when executed by the computer, the program is configured to execute:
in a case where the terms of the contract includes a first terms, setting a first amount of shipment to a unit-shipment-amount indicating an amount of the first consumables shipped at a time to the user; and
in a case where the terms of the contract includes a second term indicating an amount of the first consumables consumed in the printer in a corresponding-period is larger than that of the first term, setting a second amount of shipment to the unit-shipment-amount, the amount of the first consumables indicated by the second amount of shipment being larger than that indicated by the first amount of shipment, the corresponding-period being a period corresponding to a corresponding one term of each of the first term and the second term of the contract.

2. The non-transitory storage medium according to claim 1,
wherein, when executed by the computer, the program is configured to execute:
in the case where the terms of the contract includes the first terms indicating the corresponding-period of the first term is a first corresponding-period, setting the first amount of shipment to the unit-shipment-amount; and
in the case where the terms of the contract includes the second term indicating the corresponding-period of the second term is a second corresponding-period longer than that of the first corresponding-period, setting the second amount of shipment to the unit-shipment-amount.

3. The non-transitory storage medium according to claim 1,
wherein the terms of the contract includes a term indicating a contracted-amount, the contracted-amount being a threshold amount of an amount of second consumables consumed in the printer while the first consumables are consumed, the threshold amount being related to a rate system of the second consumables,
wherein the rate system includes at least two rate determining ways respectively determining rates of the second consumables (i) in a case where a consumed amount of the second consumables in the printer is equal to or smaller than the contracted-amount and (ii) in a case where the consumed amount of the second consumables in the printer is larger than the contracted-amount, and
wherein, when executed by the computer, the program is configured to execute:
in a case where the terms of the contract includes the first term indicating the contracted-amount is a first contracted-amount, setting the firs amount of shipment to the unit-shipment-amount; and
in a case where the terms of the contract includes the second term indicating the contracted-amount is a second contracted-amount larger than the first contracted-amount, setting the second amount of shipment to the unit-shipment-amount.

4. The non-transitory storage medium according to claim 1,
wherein the management device is communicatable with the printer, a terminal of the user, or the printer and the terminal of the user, and
wherein, when executed by the computer, the program is configured to execute:
causing the printer, the terminal of the user or the printer and the terminal of the user to obtain information indicating which one of the first amount of shipment and the second amount of shipment is to be set to the unit-shipment-amount in the case where the terms of content includes the second term;
in a case where the terms of the contract includes the second term and the obtained information indicates the first amount of shipment is to be set to the unit-shipment-amount, setting the first amount of shipment to the unit-shipment-amount; and
in a case where the terms of the contract includes the second term and the obtained information indicates the second amount of shipment is to be set to the unit-shipment-amount, setting the second amount of shipment to the unit-shipment-amount.

5. The non-transitory storage medium according to claim 4,
wherein the terms of contract includes a term regarding a contract rate, and
wherein, executed by the computer, the program is configured to execute:
in a case where the terms of the contract includes the first term indicating the contract rate is a first contract rate, setting the first amount of shipment to the unit-shipment-amount,
in a case where the terms of the contract includes the second term indicating the contract rate is a second contract rate higher than the first contract rate, setting the first amount of shipment or the second amount of shipment to the unit-shipment-amount; and
in a case where the obtained information indicates the second amount of shipment is to be set to the unit-shipment amount, changing the second contract rate to a discount contract rate lower than the second contract rate.

6. The non-transitory storage medium according to claim 4,
wherein the terms of the contract includes a term regarding a contract rate, and
wherein, when executed by the computer, the program is configured to execute:
in a case where the terms of the contract includes the first term indicating the contract rate is a first contract rate, setting the first amount of shipment to the unit-shipment-amount;
in a case where the terms of the contract includes the second term indicating the contract rate is a second contract rate higher than the first contract rate, setting the first amount of shipment or the second amount of shipment to the unit-shipment-amount; and
in a case where the obtained information indicates the second amount of shipment is to be set to the unit-shipment-amount, granting a privilege to the user.

7. The non-transitory storage medium according to claim 5,
wherein, when executed by the computer, the program is configured to execute:
in a case where a shipping rate of the second amount of shipment of the first consumables is a first shipping rate, changing the second contract rate to a first discount contract rate lower than the second contract rate; and
in a case where the shipping rate of the second amount of shipment of the first consumables is a second shipping rate lower than the first shipping rate, changing the second contract rate to a second discount contract rate lower than the first discount contract rate.

8. The non-transitory storage medium according to claim 6,
wherein, when executed by the computer, the program is configured to execute:
in a case where a shipping rate of the second amount of shipment of the first consumables to the user is a first shipping rate, granting a first privilege to the user; and
in a case where the shipping rate of the second amount of shipment of the first consumables is a second shipping rate lower than the first shipping rate, granting, to the user, a second privilege more valuable than the first privilege.

9. The non-transitory storage medium according to claim 1,
wherein, when executed by the computer, the program is configured to execute:
in the case where the terms of the contract includes the second term, determining an estimated-consumption-amount indicating an estimated amount of the first consumables estimated to be consumed in the printer by the user in the corresponding-period; and
in the case where the terms of the contract includes the second term, setting the second amount of shipment based on the determined estimated-consumption-amount to the unit-shipment-amount.

10. The non-transitory storage medium according to claim 1,
wherein, when executed by the computer, the program is configured to execute:
in the case where the terms of the contract includes the second term, determining a specified-consumption-amount indicating an amount of the first consumables consumed in the printer by the user in a past specified period; and
in the case where the terms of the contract includes the second terms and a future specified period corresponding to the past specified period is included in a predetermined set period, setting the second amount of shipment based on the specified-consumption-amount to the unit-shipment-amount.

11. The non-transitory storage medium according to claim 1,
wherein the management device is communicatable with the printer, a terminal of the user, or the printer and the terminal of the user, and
wherein, when executed by the computer, the program is configured to execute:
causing the printer, the terminal of the user, or the printer and the terminal of the user to obtain information designating a maximum limit of the unit-shipment-amount; and
in the case where the terms of the contract includes the second term, setting the second amount of shipment to the unit-shipment-amount, the amount of shipment of the second amount of shipment being equal to or smaller than the maximum limit of the unit-shipment-amount designated by the obtained information.

12. The non-transitory storage medium according to claim 1,
wherein, when executed by the computer, the program is configured to execute, in a case where the terms of the contract includes the second term, setting the second amount of shipment based on an expiration date of the first consumables to the unit-shipment-amount.

13. A management system, comprising:
a printer configured to consume first consumables; and
a management device communicatable with the printer, a terminal of the user, or the printer and the terminal of the user, the management device being configured to manage shipment of the first consumables to the user under a contract with the user,
wherein the printer, the terminal of the user, or the printer and the terminal of the user includes a first controller,
wherein the first controller is configured to execute transmitting the terms of the contract to the management device,
wherein the management device includes a second controller, and
wherein the second controller is configured to execute:
receiving the transmitted terms of the contract,
in a case where the terms of the contract includes a first term, setting a first amount of shipment to a unit-shipment-amount indicating an amount of the first consumables shipped to at a time to the user; and
in a case where the terms of the contract includes a second term indicating an amount of the first consumables consumed in the printer in a corresponding-period is larger than that of the first term, setting a second amount of shipment to the unit-shipment-amount, the amount of the first consumables indicated by the second amount of shipment being larger than that indicated by the first amount of shipment, the corresponding-period being a period corresponding to a corresponding one term of each of the first term and the second term of the contract.

14. A management device configured to manage shipment, to a user, of first consumables consumed in a printer under a contract with the user, comprising
a controller;
wherein the controller is configured to execute:
in a case where the terms of the contract includes a first term, setting a first amount of shipment to a unit-shipment-amount indicating an amount of the first consumables shipped at a time to the user; and
in a case where the terms of the contract includes a second term indicating an amount of the first consumables consumed in the printer in a corresponding-period is larger than that of the first term, setting a second amount of shipment to the unit-shipment-amount, the amount of the first consumables indicated by the second amount of shipment being larger than that indicated by the first amount of shipment, the corresponding-period being a period corresponding to a corresponding one term of each of the first term and the second term of the contract.

15. A method of managing shipment, to a user, of first consumables consumed in a printer under a contract with the user, the method comprising:
in a case where the terms of the contract includes a first term, setting a first amount of shipment to a unit-shipment-amount indicating an amount of the first consumables shipped at a time to the user; and
in a case where the terms of the contract includes a second term indicating an amount of the first consumables consumed in the printer in a corresponding-period is larger than that of the first term, setting a second amount of shipment to the unit-shipment-amount, the amount of the first consumables indicated by the second amount of shipment being larger than that indicated by the first amount of shipment, the corresponding-period being a period corresponding to a corresponding one term of each of the first term and the second term of the contract.
